(19) United States
(12) Patent Application Publication
(10) Pub. No.: US 2013/0139659 A1
(43) Pub. Date: Jun. 6, 2013

(54) Pivotal Wrench

(71) Applicant: Chung-Cheng Yang, Taichung City (TW)

(72) Inventor: Chung-Cheng Yang, Taichung City (TW)

(21) Appl. No.: 13/310,842

(22) Filed: Dec. 5, 2011

(51) Int. Cl. B25B 23/16; B25B 15/02

(52) U.S. Cl. 81/460; 81/177.7

(57) ABSTRACT

A pivotal wrench includes a handle having a first pivot portion provided with first positioning holes, a tool head having a second pivot portion provided with second positioning holes, a connector pivotally connected between the handle and the tool head, two positioning members each mounted in the connector and each positioned in one of the first positioning holes and one of the second positioning holes, and an elastic member mounted in the connector and biased between the positioning members. Thus, the handle is pivoted relative to the connector, and the tool head is pivoted relative to the connector, so that the working angles of the handle and the tool head can be adjusted freely, and the pivotal wrench is available for a limited or narrow working place.

### BACKGROUND OF THE INVENTION

1. Field of the Invention

The present invention relates to a wrench and, more particularly, to a pivotal wrench for operating a screw member, such as a screw, nut, bolt and the like.

2. Description of the Related Art

A conventional wrench comprises a handle and a tool head. Thus, the conventional wrench is used to drive and rotate a screw member, such as a screw, nut, bolt and the like. However, the conventional wrench has a fixed structure so that the working angles of the handle and the tool head cannot be adjusted freely, and the conventional wrench cannot be easily operated in a narrow place, such as an engine room and the like, thereby greatly causing inconvenience to the user when operating the conventional wrench in the narrow place.

### BRIEF SUMMARY OF THE INVENTION

In accordance with the present invention, there is provided a pivotal wrench, comprising a handle, a connector connected with the handle, and a tool head connected with the connector. The handle has a first end provided with a semi-circular first pivot portion. The first pivot portion of the handle has a central section provided with a first pivot hole. The first pivot portion of the handle has an arcuate surface provided with a plurality of first positioning holes which are equally distant from each other. The tool head has a first end provided with a semi-circular second pivot portion. The second pivot portion of the tool head has a central section provided with a second pivot hole. The second pivot portion of the tool head has an arcuate surface provided with a plurality of second positioning holes which are equally distant from each other. The connector is pivotally connected between the handle and the tool head. The connector has two slots which are formed on two opposite ends of the connector and are mounted on the first pivot portion of the handle and the second pivot portion of the tool head respectively. Each of the slots of the connector has a first side provided with a through hole and a second side provided with a screw bore. The through hole and the screw bore of each of the slots of the connector are aligned with the first pivot hole of the handle and the second pivot hole of the tool head respectively. The connector has an interior provided with a radial receiving hole connected between the slots of the connector. The pivotal wrench further comprises two pivot screws each extended through the respective through hole of the connector and the first pivot hole of the handle and the second pivot hole of the tool head and each screwed into the respective screw bore of the connector, two positioning members each mounted in the receiving hole of the connector and each positioned in one of the first positioning holes of the handle and one of the second positioning holes of the tool head, and an elastic member mounted in the receiving hole of the connector and biased between the positioning members.

The primary objective of the present invention is to provide a pivotal wrench whose working angles can be adjusted freely.

According to the primary advantage of the present invention, the handle is pivoted relative to the connector to change the angle between the handle and the connector arbitrarily, and the tool head is pivoted relative to the connector to change the angle between the tool head and the connector arbitrarily, so that the working angles of the handle and the tool head can be adjusted freely, and the pivotal wrench is available for a limited or narrow working place.

According to another advantage of the present invention, one of the positioning members is selectively positioned in any one of the first positioning holes of the handle by the elastic force of the elastic member to position the handle temporarily so that the handle is secured on the connector solidly and stably, and the other one of the positioning members is selectively positioned in any one of the second positioning holes of the tool head by the elastic force of the elastic member to position the tool head temporarily so that the tool head is secured on the connector solidly and stably.

Further benefits and advantages of the present invention will become apparent after a careful reading of the detailed description with appropriate reference to the accompanying drawings.

### BRIEF DESCRIPTION OF THE SEVERAL VIEWS OF THE DRAWING(S)

FIG. 1 is a perspective view of a pivotal wrench in accordance with the preferred embodiment of the present invention.

FIG. 2 is an exploded perspective view of the pivotal wrench as shown in FIG. 1.

FIG. 2a is a locally enlarged perspective cross-sectional view of a connector of the pivotal wrench as shown in FIG. 2.

FIG. 3 is a front cross-sectional view of the pivotal wrench as shown in FIG. 1.

FIG. 4 is a top cross-sectional view of the pivotal wrench as shown in FIG. 1.

FIG. 5 is a schematic operational view of the pivotal wrench as shown in FIG. 1 in use.

FIG. 6 is a partially top cross-sectional view of the pivotal wrench as shown in FIG. 5.

FIG. 7 is a partially top cross-sectional operational view of the pivotal wrench as shown in FIG. 1.

FIG. 8 is a perspective view of a pivotal wrench in accordance with another preferred embodiment of the present invention.

FIG. 9 is a schematic operational view of the pivotal wrench as shown in FIG. 8 in use.

### DETAILED DESCRIPTION OF THE INVENTION

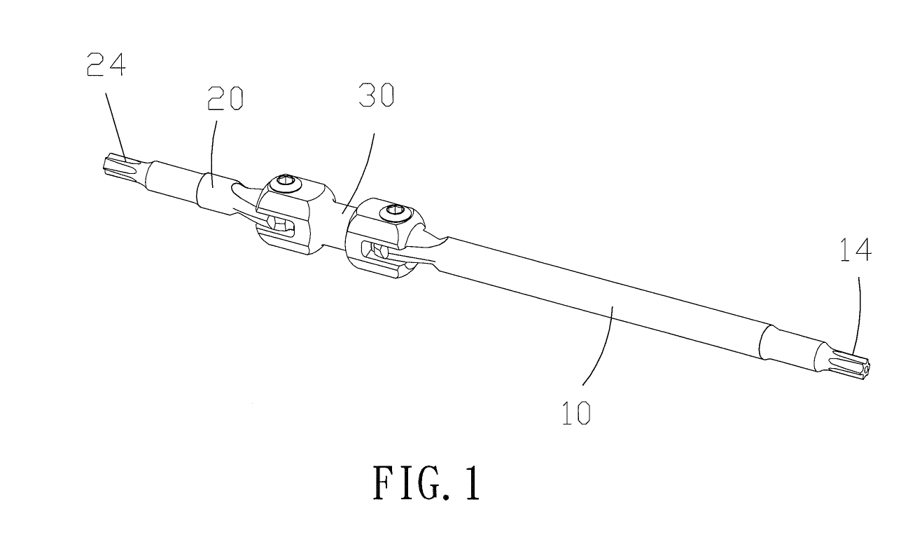

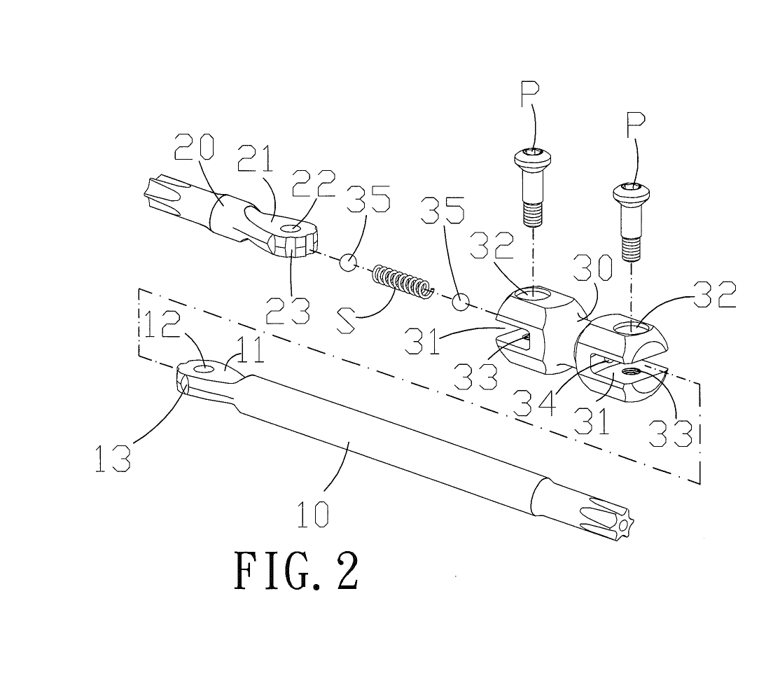

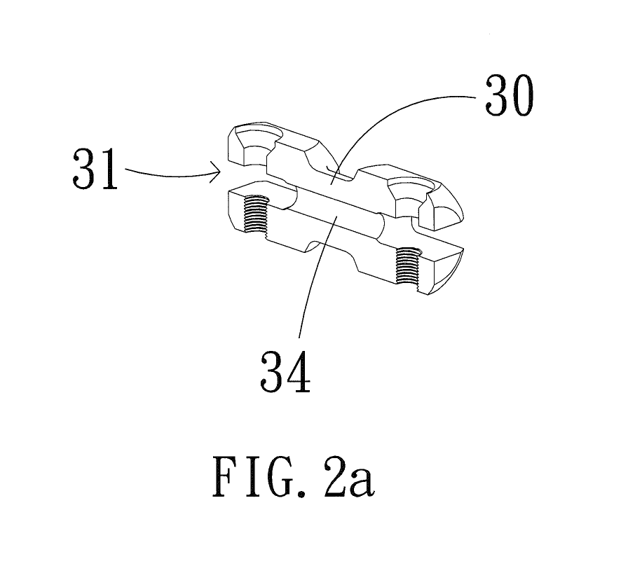

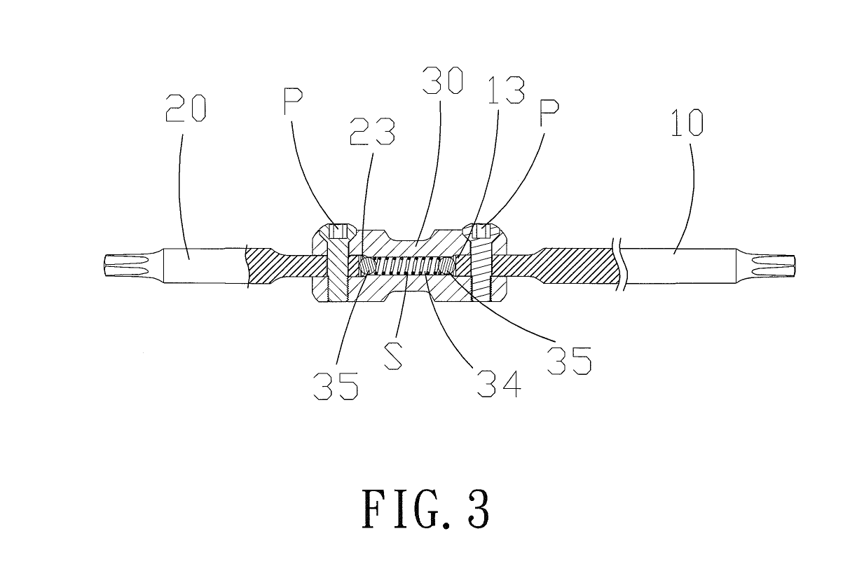

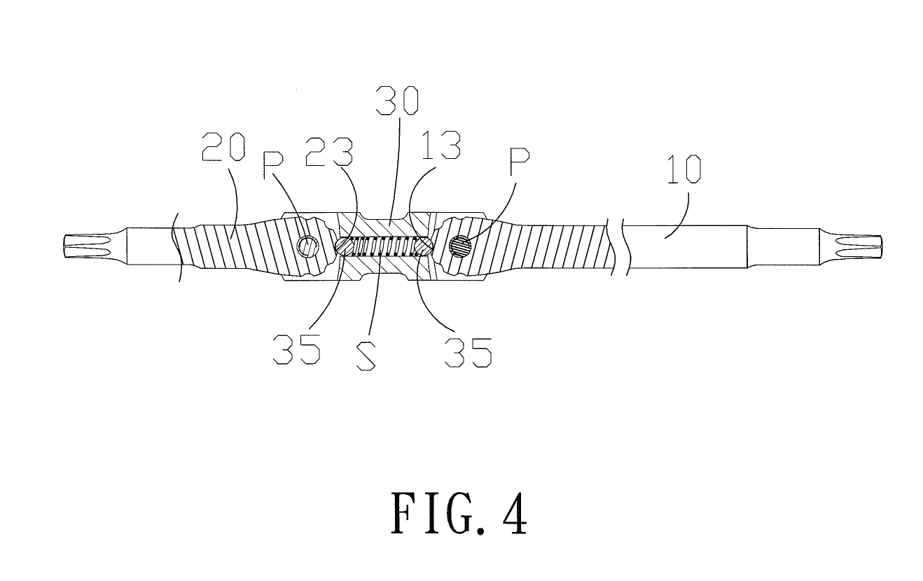

Referring to the drawings and initially to FIGS. 1-4, a pivotal wrench in accordance with the preferred embodiment of the present invention comprises a handle 10, a connector 30 connected with the handle 10, and a tool head 20 connected with the connector 30.

The handle 10 has a first end provided with a semi-circular first pivot portion 11. The first pivot portion 11 of the handle 10 has a central section provided with a first pivot hole 12. The first pivot portion 11 of the handle 10 has an arcuate surface provided with a plurality of first positioning holes 13 which are equally distant from each other.

The tool head 20 has a first end provided with a semi-circular second pivot portion 21. The second pivot portion 21 of the tool head 20 has a central section provided with a second pivot hole 22. The second pivot portion 21 of the tool head 20 has an arcuate surface provided with a plurality of second positioning holes 23 which are equally distant from each other.

The connector 30 is pivotally connected between the handle 10 and the tool head 20. The connector 30 has two slots 31 which are formed on two opposite ends of the connector 30 and are mounted on the first pivot portion 11 of the handle 10 and the second pivot portion 21 of the tool head 20 respectively. Each of the slots 31 of the connector 30 has a first side provided with a through hole 32 and a second side provided with a screw bore 33. The through hole 32 and the screw bore 33 of each of the slots 31 of the connector 30 are aligned with the first pivot hole 12 of the handle 10 and the second pivot hole 22 of the tool head 20 respectively. The connector 30 has an interior provided with a radial receiving hole 34 connected between the slots 31 of the connector 30.

The pivotal wrench further comprises two pivot screws “P” each extended through the respective through hole 32 of the connector 30 and the first pivot hole 12 of the handle 10 and the second pivot hole 22 of the tool head 20 and each screwed into the respective screw bore 33 of the connector 30, two positioning members 35 each mounted in the receiving hole 34 of the connector 30 and each positioned in one of the first positioning holes 13 of the handle 10 and one of the second positioning holes 23 of the tool head 20, and an elastic member “S” mounted in the receiving hole 34 of the connector 30 and biased between the positioning members 35. Preferably, each of the positioning members 35 is a steel ball.

In assembly, the positioning members 35 and the elastic member “S” are initially received in the receiving hole 34 of the connector 30. Then, the first pivot portion 11 of the handle 10 is inserted into one of the slots 31 of the connector 30, and the first pivot hole 12 of the handle 10 is aligned with the respective through hole 32 and the respective screw bore 33 of the connector 30. Then, the second pivot portion 21 of the tool head 20 is inserted into the other one of the slots 31 of the connector 30, and the second pivot hole 22 of the tool head 20 is aligned with the respective through hole 32 and the respective screw bore 33 of the connector 30. Then, one of the pivot screws “P” is extended through the respective through hole 32 of the connector 30 and the first pivot hole 12 of the handle 10 and is screwed into the respective screw bore 33 of the connector 30 so that the handle 10 is pivotally connected with the connector 30. Then, the other one of the pivot screws “P” is extended through the respective through hole 32 of the connector 30 and the second pivot hole 22 of the tool head 20 and is screwed into the respective screw bore 33 of the connector 30 so that the tool head 20 is pivotally connected with the connector 30. At this time, one of the positioning members 35 is selectively positioned in any one of the first positioning holes 13 of the handle 10, and the other one of the positioning members 35 is selectively positioned in any one of the second positioning holes 23 of the tool head 20 by the elastic force of the elastic member “S”.

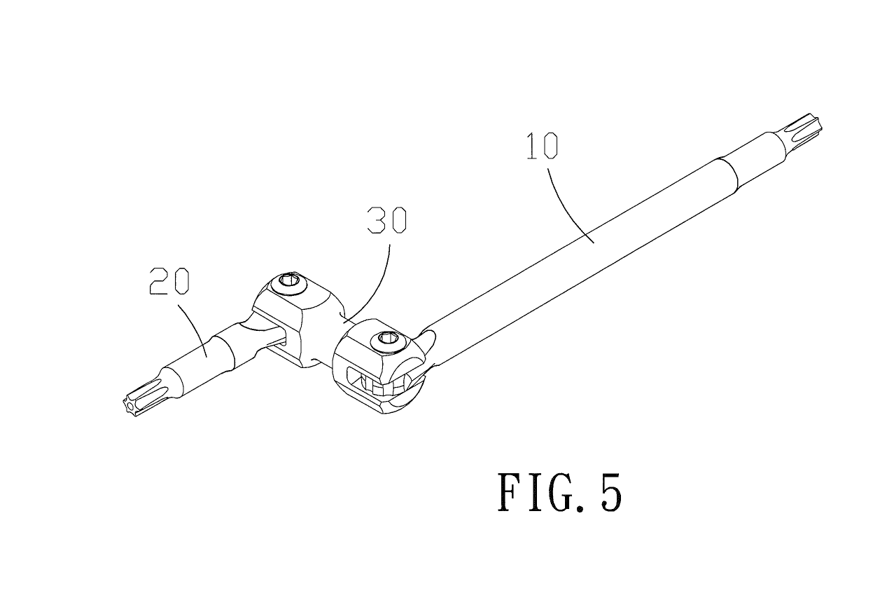

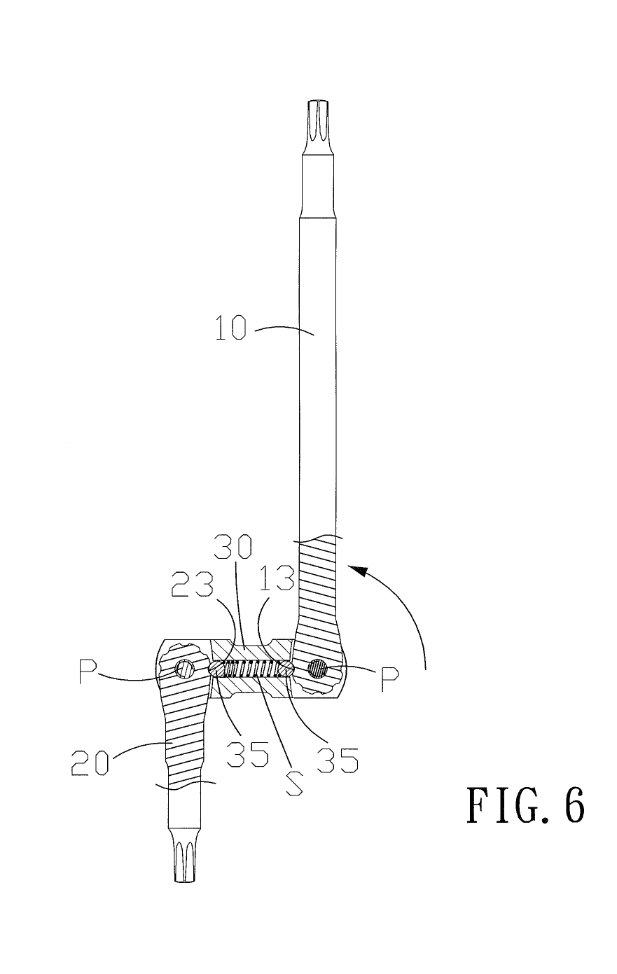

In operation, referring to FIGS. 5 and 6 with reference to FIGS. 1-4, the first pivot portion 11 of the handle 10 is pivotally mounted in one of the slots 31 of the connector 30, and the first pivot hole 12 of the handle 10 is pivotable about one of the pivot screws “P” so that the handle 10 is pivotable relative to the connector 30 to change the angle between the handle 10 and the connector 30. In addition, the second pivot portion 21 of the tool head 20 is pivotally mounted in the other one of the slots 31 of the connector 30, and the second pivot hole 22 of the tool head 20 is pivotable about the other one of the pivot screws “P” so that the tool head 20 is pivotable relative to the connector 30 to change the angle between the tool head 20 and the connector 30.

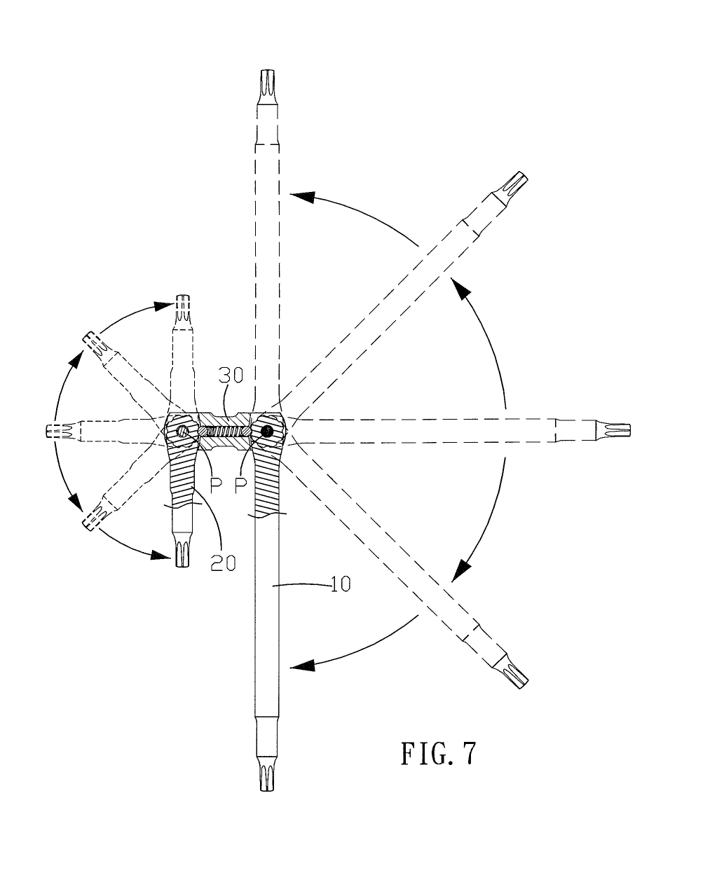

Referring to FIG. 7 with reference to FIGS. 1-4, the handle 10 is pivoted relative to the connector 30 to change the angle between the handle 10 and the connector 30 arbitrarily, and the tool head 20 is pivoted relative to the connector 30 to change the angle between the tool head 20 and the connector 30 arbitrarily. At this time, one of the positioning members 35 is selectively positioned in any one of the first positioning holes 13 of the handle 10 by the elastic force of the elastic member “S” to position the handle 10 temporarily, and the other one of the positioning members 35 is selectively positioned in any one of the second positioning holes 23 of the tool head 20 by the elastic force of the elastic member “S” to position the tool head 20 temporarily. Thus, the working angles of the handle 10 and the tool head 20 can be adjusted freely so that the pivotal wrench is available for a limited working place, such as an engine room and the like.

As shown in FIG. 1, the handle 10 has a second end provided with a star-shaped first tip 14, and the tool head 20 has a second end provided with a star-shaped second tip 24.

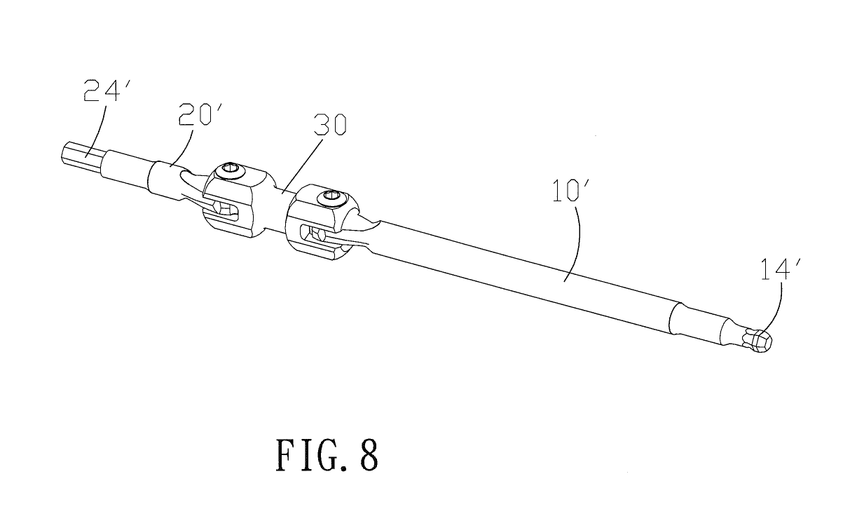

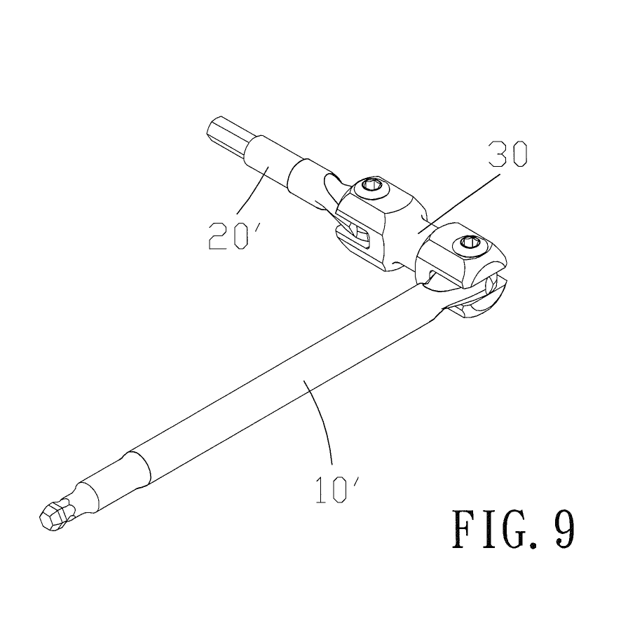

Referring to FIGS. 8 and 9, the handle 10′ has a second end provided with a hexagonal first tip 14′, and the tool head 20′ has a second end provided with a hexagonal second tip 24′.

Accordingly, the handle 10 is pivoted relative to the connector 30 to change the angle between the handle 10 and the connector 30 arbitrarily, and the tool head 20 is pivoted relative to the connector 30 to change the angle between the tool head 20 and the connector 30 arbitrarily, so that the working angles of the handle 10 and the tool head 20 can be adjusted freely, and the pivotal wrench is available for a limited or narrow working place. In addition, one of the positioning members 35 is selectively positioned in any one of the first positioning holes 13 of the handle 10 by the elastic force of the elastic member “S” to position the handle 10 temporarily so that the handle 10 is secured on the connector 30 solidly and stably, and the other one of the positioning members 35 is selectively positioned in any one of the second positioning holes 23 of the tool head 20 by the elastic force of the elastic member “S” to position the tool head 20 temporarily so that the tool head 20 is secured on the connector 30 solidly and stably.

Although the invention has been explained in relation to its preferred embodiment(s) as mentioned above, it is to be understood that many other possible modifications and variations can be made without departing from the scope of the present invention. It is, therefore, contemplated that the appended claim or claims will cover such modifications and variations that fall within the true scope of the invention.

1. A pivotal wrench, comprising:
a handle;
a connector connected with the handle; and
a tool head connected with the connector;
wherein the handle has a first end provided with a semi-circular first pivot portion;
the first pivot portion of the handle has a central section provided with a first pivot hole;
the first pivot portion of the handle has an arcuate surface provided with a plurality of first positioning holes which are equally distant from each other;
the tool head has a first end provided with a semi-circular second pivot portion;
the second pivot portion of the tool head has a central section provided with a second pivot hole;
the second pivot portion of the tool head has an arcuate surface provided with a plurality of second positioning holes which are equally distant from each other;
the connector is pivotally connected between the handle and the tool head;
the connector has two slots which are formed on two opposite ends of the connector and are mounted on the first pivot portion of the handle and the second pivot portion of the tool head respectively;
each of the slots of the connector has a first side provided with a through hole and a second side provided with a screw bore;
the through hole and the screw bore of each of the slots of the connector are aligned with the first pivot hole of the handle and the second pivot hole of the tool head respectively;
the connector has an interior provided with a radial receiving hole connected between the slots of the connector;
the pivotal wrench further comprises:
two pivot screws each extended through the respective through hole of the connector and the first pivot hole of the handle and the second pivot hole of the tool head and each screwed into the respective screw bore of the connector;
two positioning members each mounted in the receiving hole of the connector and each positioned in one of the first positioning holes of the handle and one of the second positioning holes of the tool head; and
an elastic member mounted in the receiving hole of the connector and biased between the positioning members.

2. The pivotal wrench of claim 1, wherein each of the positioning members is a steel ball.

3. The pivotal wrench of claim 1, wherein the handle has a second end provided with a star-shaped or hexagonal first tip.

4. The pivotal wrench of claim 1, wherein the tool head has a second end provided with a star-shaped or hexagonal second tip.
